(19) United States
(12) Patent Application Publication
(10) Pub. No.: US 2009/0052620 A1
(43) Pub. Date: Feb. 26, 2009

(54) Apparatus and Method for X-Ray Analysis of Chemical State

(75) Inventor: Masaru TAKAKURA, Tokyo (JP)

Correspondence Address: THE WEBB LAW FIRM, P.C., 700 KOPPERS BUILDING, 436 SEVENTH AVENUE, PITTSBURGH, PA, 15219, US

(73) Assignee: JEOL LTD., Tokyo (JP)

(21) Appl. No.: 12/194,608

(22) Filed: Aug. 20, 2008

(30) Foreign Application Priority Data
Aug. 21, 2007 (JP) 2007-214740

(51) Int. Cl. G01N 23/223

(52) U.S. Cl. 378/45

(57) ABSTRACT

A state analysis using characteristic X-rays of higher-order diffractions. The name of an element undergoing a state analysis, a species of characteristic X-rays, and a diffraction order are entered from an input device. A measurement control unit reads data about the wavelengths of first-order lines from a storage device in accordance with the specified species of the characteristic X-rays, and finds the actual spectral wavelength position and range of measured wavelengths based on the diffraction order.

### BACKGROUND OF THE INVENTION

1. Field of the Invention

The present invention relates to apparatus and method for analyzing a sample by X-ray spectroscopy by irradiating the sample with an electron beam or X-rays and spectrally resolving and detecting characteristic X-rays emitting from the sample by a wavelength-dispersive X-ray spectrometer (WDS). More specifically, the invention relates to apparatus and method for analyzing the chemical state in a sample by making use of variations in and among characteristic X-ray spectra.

2. Description of Related Art

An electron probe microanalyzer (EPMA) is an X-ray analyzer for analyzing a sample by irradiating it with an electron beam and spectrally resolving and detecting characteristic X-rays emitting from the sample by a wavelength-dispersive X-ray spectrometer. FIG. 10 is a schematic diagram illustrating the principle of operation of WDS equipped to EPMA.

The X-ray spectrometer of FIG. 10 has an analyzing crystal 5 having a diffraction plane whose center is indicated by C. The center C moves on a straight-line segment SC that is tilted at an angle of α (X-ray take off angle) to the horizontal plane from a point S at which X-rays are produced. At this time, the point S at which the X-rays are produced, the center C of the diffraction plane of the analyzing crystal 5, and the center F of a slit formed in an X-ray detector 6 are always present on the circumference of a Rowland circle RC having a constant radius R. The position of the center F of the slit in the front of the X-ray detector 6 and the center Q of the Rowland circle are moved such that the line segments SC and CF are kept equal in length at all times. With respect to the crystal lattice planes, the diffraction plane of the analyzing crystal 5 curved at a curvature of 2R about a point D is made to face the center Q of the Rowland circle at all times. The length of the line segment SC is represented by a spectral position L and given by

L=2R×sin θ (1)

where θ is the angle of incidence of X-rays on the center C of the diffraction plane (i.e., the angle that a straight line C1 passing through the center C of the diffraction plane and circumscribing the Rowland circle RC makes to the straight-line segment SC).

Meanwhile, for the diffraction conditions for the analyzing crystal, it can be seen from the Bragg's condition that the following relationship holds:

2d×sin θ=n×λ (2)

where λ is the wavelength of X-rays and d is the spacing of planes in the analyzing crystal. n is a diffraction order assuming a positive integer. Diffraction lines with n equal to or greater than 2 are generally referred to as higher-order diffraction lines or simply as higher-order lines. Eqs. (1) and (2) lead to

L=(2R/2d)×n×λ (3)

It is possible to know the wavelength λ of the diffracted characteristic X-rays by measuring the spectral position L. Because characteristic X-rays have wavelengths intrinsic to each element, the elements contained in the sample can be identified from the wavelengths λ. Furthermore, the concentrations of the elements contained in the sample can be known from the measured intensities of the characteristic X-rays.

A dispersion element that is not strictly a crystal, such as a Langmuir-Blodgett (LB) film or an artificial multilayer film (artificial superlattice), is used in a practical WDS. In the present specification, all of them are conveniently referred to as analyzing crystals. Dispersion elements referred to herein embrace all analyzing crystals, diffraction gratings, and so on which spectrally resolve X-rays based on the Bragg's condition.

FIG. 3 is a graph illustrating a method of displaying a characteristic X-ray spectrum (hereinafter may be abbreviated “a spectrum”) acquired by the wavelength-dispersive X-ray spectrometer shown in FIG. 10. In FIG. 3, a spectrum of characteristic X-ray W-Mβ line of tungsten is shown. Plural different units of representation are plotted on the horizontal axis of FIG. 3. X-ray intensity is plotted on the vertical axis. Some methods are available to represent the horizontal axis according to the purpose of display. Plotting wavelength (in nm or Å) or energy (in KeV or eV) is a method of display independent of the kind of the analyzing crystal and of the size of the X-ray spectrometer. As can be seen from Eq. (2), the diffraction angle θ (normally, represented by twice of θ, or 2θ) or sin θ is not associated with the size of the X-ray spectrometer but is determined dependent on the kind of the analyzing crystal (i.e., plane spacing d). As can be seen from Eq. (3), the spectral position L is determined dependent on both the kind of the analyzing crystal and the size of the X-ray spectrometer. In the following description, the horizontal axis of a spectrum may be conveniently referred to as the “wavelength axis” irrespective of the unit of display.

Species of characteristic X-rays released from elements constituting a sample have many kinds for each element, including Kα-line, Kβ-line, Lα-line, Lβ-line, Mα-line, and Mβ-line. Furthermore, a spectrum spectrally resolved with WDS contains many higher-order lines. A technique for facilitating identifying elements by analyzing such complex spectra is disclosed, for example, in JP-B-6-97213. In this technique, with respect to characteristic X-rays of a specified element, markers are displayed at spectral positions where higher-order lines appear, as well as at the positions of the first-order diffraction lines.

In elemental analysis, higher-order lines hinder observation of the first-order lines used for analysis and, thus, are to be eliminated. For example, JP-A-2002-357571 discloses a technique for a wavelength-dispersive X-ray fluorescence analyzer to remove the background arising from higher-order lines by the use of a multichannel pulse height analyzer.

JP-A-2006-58015 discloses a technique for removing higher-order lines by making use of a multichannel analyzer (MCA) equipped to an energy-dispersive X-ray spectrometer (EDS).

A known method uses a spectrum of characteristic X-rays released from a sample to analyze the chemical state in elements constituting a substance. Where the chemical state in an element of interest is analyzed (hereinafter may be abbreviated “chemical state analysis” or “state analysis”) using a spectrum of characteristic X-rays, the analysis is performed utilizing variations in spectral wavelength (energy) and spectral waveform due to different chemical states, as well as variations in intensity between plural characteristic X-ray species. For example, JP-A-2003-75376 discloses a technique for analyzing the chemical state in tungsten based on the intensities of W-Mα line and Mβ-line of the characteristic X-rays from tungsten measured by an electron probe microanalyzer (EPMA).

In state analysis using variations in characteristic X-ray spectra, it is advantageous to select measurement conditions under which the spectral wavelength or energy resolution is optimized. Therefore, in available methods, an analyzing crystal providing a high wavelength resolution or an analyzing crystal having a plane spacing maximizing the measured diffraction angle of characteristic X-rays is selected. One method of these measuring techniques is to use higher-order diffraction lines. For example, Japanese Patent No. 2,759,922 discloses a technique employing higher-order reflections from an analyzing crystal in EXAFS spectroscopy using X-ray fluorescence analysis. EXAFS spectroscopy is a technique of performing a structural analysis using an absorption spectrum obtained near an X-ray absorption end. One of the reasons why higher-order diffractions are used is the same as why characteristic X-rays of higher-order diffractions are used in order to improve the wavelength resolution for state analysis.

FIG. 4 is a schematic graph illustrating the relationships of first-order lines to second-order diffraction lines used for normal analysis. Wavelength or energy is plotted on the horizontal axis. X-ray intensity is plotted on the vertical axis. It is assumed that characteristic X-rays A1 and B1 of first-order diffractions have wavelengths of λa and μb, respectively, and half-value widths of Δλa and Δλb, respectively. It is also assumed that they have energies of Ea and Eb, respectively. Second-order lines A2 and B2 of the first-order lines A1 and B1 are detected at spectral positions 2λa and 2λb, respectively, which are twice as large as the wavelengths of λa and λb, respectively, of the spectrometer. At this time, the half-value widths of the second-order lines A2 and B2 are substantially identical with the half-value widths Δλa and Δλb, respectively, of the first-order lines. Generally, there is the problem that higher-order lines have lower intensities of X-rays than the first-order lines. However, as can be seen from FIG. 4, higher-order diffractions produce dispersions larger by amounts corresponding to the orders than the first-order diffractions. Therefore, if higher-order lines are used, an analysis can be performed at relatively large spectral resolution provided that the half-value widths Δλa and Δλb of peaks remain the same. At this time, the energies of the second-order lines A2 and B2 are the same as the energies Ea and Eb, respectively, of the first-order lines A1 and B1. Apparently, spectra of second-order lines A2 and B2 appear at the positions of Ea/2 and Eb/2. Consequently, it is to be noted that energies possessed by the first-order lines of other elements appearing near these spectra are about half of Ea and Eb in magnitude.

As shown in FIG. 10, an analyzing crystal whose diffraction plane has been curved in the direction of dispersion is used as a wavelength-dispersive X-ray spectrometer equipped to EPMA. For this reason, in spectral regions where the diffraction angles are small, X-ray spectra may be distorted due to incompleteness of geometrical light gathering caused by incompleteness of the machining of the diffraction plane and incompleteness of the curved plane. However, higher-order lines produce larger diffraction angles than first-order lines. Therefore, if higher-order lines are used, distortion of the spectra will be mitigated. As a result, it is expected that more accurate state analysis will be performed.

One example of substance undergoing a state analysis using higher-order lines is magnesium. FIG. 5 is a schematic graph illustrating an example in which second-order lines of Mg-Kα line having a wavelength of 0.9889 nm are used when the chemical state in magnesium is analyzed. The wavelength is plotted on the horizontal axis. X-ray intensity is plotted on the vertical axis. In the technique described in the above-cited JP-A-2003-75376, the upper limit of wavelength λp of the spectral range of an analyzing crystal of PET (pentaerythritol) used for measurements of the W-Mα line and Mβ line has a value of about 0.812 nm, that is slightly different among instruments. In consequence, it is impossible to spectrally detect the Mg-Kα line. On the other hand, in the case of an analyzing crystal of TAP (thallium acid phthalate) which is one of the analyzing crystals commonly used in EPMA and which has a larger plane spacing than that of an analyzing crystal of PET, the upper limit of wavelength λt of the spectral range has a value of about 2.392 nm that is slightly different among instruments. Therefore, all of the first- and second-order lines of Mg-Kα line can be spectrally resolved with a TAP crystal. The lower limit of wavelength of the spectral range of the TAP crystal exists, but is not shown. As described previously, where analysis is performed while placing emphasis on the wavelength resolution, second-order lines of the Mg-Kα line employing TAP are used.

An X-ray analysis apparatus, such as EPMA or X-ray fluorescence spectrometer, is used, first of all, for elemental analysis, such as elemental identification (qualitative analysis) or quantitative analysis. State analysis, especially a method using higher-order diffraction lines, is one mode of usage of the apparatus but is less popular than elemental analysis. Therefore, these X-ray analysis apparatus are so devised that priority is placed on efficient implementation of element analysis in both hardware and software. For example, in many highly computerized apparatus operated under computer control, if the name of an element to be analyzed and characteristic X-ray species used for analysis are specified, analytical conditions are so set that an analyzing crystal is automatically set to the wavelength position of the first-order line.

Furthermore, the wavelength range in which a spectrum is acquired (scanning range of the analyzing crystal) must be widened according to the order of diffraction of a higher-order line. Therefore, if a second-order line is used, for example, to perform a state analysis, it is necessary to find a wavelength of twice of that of the first-order line and the scanning range of the analyzing crystal by manual computations.

In addition, an apparatus capable of highly automated element analysis may be equipped with a function of automatically setting a pulse height analyzer (PHA) equipped to the WDS, based on the energy value of the first-order line corresponding to the position of the spectral wavelength so as to remove higher-order lines. Where higher-order lines are used for analysis, the PHA must be set such that the first-order line diffracted at that wavelength position is removed, contrary to the case of elemental analysis.

FIGS. 6, 7, and 8 are graphs illustrating operations for sorting X-ray signals according to energy using a pulse height analyzer (PHA). For example, a case is now considered where a second-order line A2 appeared in a position corresponding to a wavelength twice as long as λa is used for state analysis but a first-order line C1 having a wavelength of λc exists close to A2 as shown in FIG. 6. Under this condition, the apparent wavelength 2λa of A2 and the wavelength λc of C1 are close to each other and so the energy Ea of A2 is almost twice as large as the energy Ec of C1.

FIGS. 7 and 8 are graphs illustrating a method of sorting X-ray signals by a single-channel analyzer (SCA) equipped to a PHA. The magnitude of an electrical pulse proportional to the energy of an X-ray photon detected by an X-ray detector (i.e., X-ray signal pulse height value) is plotted on the horizontal axis. The signal is so amplified that the pulse height values of the electrical pulses to be selected are contained within a range from 0 to 10 volts (V). The total count of X-ray photons extracted from the X-ray detector corresponding to the pulse height values of electrical pulses is plotted on the vertical axis. Where an elemental analysis is performed, a window (see FIG. 7) is so set that only signals centered at energy Ec of the first-order line are selected by the SCA as shown in FIG. 7.

However, where second-order lines are used for state analysis, the gain for electrical pulses and the window (see FIG. 8) must be set such that signals centered at energy Ea of second-order lines are selected.

It is relatively rare that a second-order line is used for a state analysis and a first-order line of another element is close to the used second-order line as in the example of FIG. 6. Generally, higher-order lines are weaker than first-order lines. Therefore, in order to remove the background of the first-order line, it is desired to sort X-ray signals using the PHA at all times.

As described previously, in order to use higher-order lines for analysis, various operations must be performed manually. For example, analytical conditions different from analytical conditions under which elemental analysis is performed are set. These operations are cumbersome for the operator to perform. In addition, there is the possibility that incorrect settings are made.

Of course, where a spectrum of higher-order lines is displayed, it is displayed as a spectrum having double wavelength if the higher-order lines are second-order lines. However, where higher-order lines are used for state analysis, the purpose is only to improve the wavelength resolution or energy resolution of the spectrum. The absolute wavelength of the spectral position of a higher-order line or an energy corresponding to a first-order line of that wavelength is meaningless. In any case, in order to obtain information about the chemical state from the obtained spectrum, it is necessary that the wavelength or energy of a higher-order line be converted into a wavelength or energy of the original first-order line and displayed. However, this function is not necessary for elemental analysis, per se. Therefore, the conventional instrument does not have such a function of automatic conversion and display. Operations for reconverting the wavelengths of spectra into the wavelengths of first-order lines according to the orders of higher-order lines and displaying the wavelengths are cumbersome for the operator to perform. In addition, these manual operations tend to be carried out incorrectly.

### SUMMARY OF THE INVENTION

It is an object of the present invention to provide a technique of automatically setting an X-ray analyzer to analytical conditions different from analytical conditions under which a general elemental analysis is performed to thereby permit measurements of higher-order lines to be performed efficiently when a state analysis is performed after spectra of the higher-order lines are acquired by a wavelength-dispersive X-ray spectrometer.

It is another object of the present invention to provide a technique of automatically reconverting the wavelength axis of a spectrum of higher-order lines acquired at high wavelength resolution for state analysis into values of the original first-order lines and displaying the values, thus permitting quick analysis of the chemical state.

A first embodiment of the present invention that achieves the foregoing objects provides an X-ray analysis apparatus for analyzing the chemical state in a sample by irradiating the sample with an electron beam and spectrally resolving and detecting characteristic X-rays emitting from the sample by a wavelength-dispersive X-ray spectrometer. The X-ray spectrometer has: specifying means for specifying an element to be analyzed in terms of the chemical state, a species of characteristic X-rays used for the analysis of the element, and its order of diffraction; setting means for setting measurement conditions under which a spectrum of the characteristic X-rays specified by the specifying means is measured; and storage means in which parameters necessary to set the measurement conditions are stored. The setting means reads out the parameters stored in the storage means based on the species of the characteristic X-rays specified by the specifying means and on its diffraction order and sets the measurement conditions under which the spectrum of the characteristic X-rays is measured.

A second embodiment of the present invention is based on the first embodiment and further characterized in that at least (i) energy and/or wavelength of the characteristic X-rays specified by the specifying means, (ii) a kind of X-ray analyzing crystal capable of measuring a spectrum of the characteristic X-rays specified by the specifying means, and (iii) a plane spacing of the X-ray analyzer is stored in the storage means.

A third embodiment of the present invention is based on the first or second embodiment and further characterized in that the setting means has means for setting a pulse height analyzer of an X-ray detection system for detecting the characteristic X-rays in such a way as to detect only diffraction lines of the second or higher order specified by the specifying means when the characteristic X-rays specified by the specifying means are diffraction lines of the second or higher order.

A fourth embodiment of the present invention is based on the first embodiment and further characterized in that the X-ray analysis apparatus further includes: conversion means for converting the wavelengths of a characteristic X-ray spectrum measured under the above-described measurement conditions into wavelengths of a spectrum of first-order diffraction lines; and display means for displaying the spectrum obtained by the conversion.

A fifth embodiment of the present invention provides an X-ray analysis apparatus for analyzing the chemical state in a sample by irradiating the sample with an electron beam and spectrally resolving and detecting characteristic X-rays emitting from the sample by a wavelength-dispersive X-ray spectrometer. The X-ray analysis apparatus has: specifying means for specifying an element to be analyzed in terms of the chemical state, a species of characteristic X-rays used for the analysis of the element, and its order of diffraction; conversion means for converting wavelengths of a characteristic X-ray spectrum measured based on the species of characteristic X-rays and order of diffraction specified by the specifying means into wavelengths of a spectrum of first-order diffraction lines; and display means for displaying the spectrum obtained by the conversion.

A sixth embodiment of the present invention provides a method of X-ray analysis for analyzing the chemical state in a sample by irradiating the sample with an electron beam and spectrally resolving and detecting characteristic X-rays emitting from the sample by a wavelength-dispersive X-ray spectrometer. This method starts with specifying an element to be analyzed in terms of the chemical state, a species of characteristic X-rays used for the analysis of the element, and its order of diffraction. Measurement conditions under which a spectrum of the specified characteristic X-rays is measured are set. Parameters necessary to set the measurement conditions are read from storage means, based on the specified species of characteristic X-rays and diffraction order, and then the measurement conditions under which a spectrum of the characteristic X-rays is measured are set.

A seventh embodiment of the present invention also provides a method of X-ray analysis for analyzing the chemical state in a sample by irradiating the sample with an electron beam and spectrally resolving and detecting characteristic X-rays emitting from the sample by a wavelength-dispersive X-ray spectrometer. This method starts with specifying an element to be analyzed in terms of the chemical state, a species of characteristic X-rays used for the analysis of the element, and its order of diffraction. The wavelengths of the characteristic X-ray spectrum measured based on the specified species of characteristic X-rays and order of diffraction are converted into wavelengths of a spectrum of first-order diffraction lines. The spectrum obtained by the conversion is displayed.

According to the first embodiment of the present invention, when chemical states in an element are analyzed using higher-order diffraction lines, measurement conditions which are suitable for measurement of a spectrum of the higher-order diffraction lines and which are different from measurement conditions adapted for measurement of a spectrum of first-order diffraction lines can be set easily, the latter measurement conditions being used for normal elemental analysis. Consequently, a high wavelength-resolution spectrum using higher-order diffraction lines can be efficiently measured.

According to the second embodiment of the present invention, parameters necessary to find the measurement conditions are read from storage means. Measurement conditions suitable for measurement of a spectrum of higher-order diffraction lines can be easily established. Therefore, a high wavelength-resolution spectrum using higher-order diffraction lines can be measured efficiently.

According to the third embodiment of the present invention, the pulse height analyzer can be set to operative conditions suitable for measurement of a spectrum of higher-order diffraction lines differently from the operative conditions of the pulse height analyzer suitable for measurement of a spectrum of first-order diffraction lines used for normal elemental analysis. Consequently, a high wavelength-resolution spectrum using higher-order diffraction lines can be measured efficiently.

According to the fourth embodiment of the present invention, a high wavelength-resolution spectrum obtained by higher-order diffractions can be easily converted into wavelengths of the original first-order diffraction lines or energy-axis and be displayed. In consequence, the chemical state can be analyzed quickly.

According to the fifth embodiment of the present invention, a high wavelength-resolution spectrum obtained by higher-order diffractions can be easily converted into wavelengths of the original first-order diffraction lines or energy axis and be displayed. Hence, the chemical state can be analyzed quickly.

According to the sixth embodiment of the invention, when chemical states in an element are analyzed using higher-order diffraction lines, measurement conditions which are suitable for measurement of a spectrum of higher-order diffraction lines and which are different from measurement conditions suitable for measurement of a spectrum of first-order diffraction lines used for normal elemental analysis can be established easily. Consequently, a high wavelength-resolution spectrum using higher-order diffraction lines can be efficiently measured.

According to the seventh embodiment of the invention, a high wavelength-resolution spectrum obtained by higher-order diffractions can be easily converted into wavelengths of the original first-order diffraction lines or energy axis and be displayed. Hence, the chemical state can be analyzed quickly.

Other objects and features of the invention will appear in the course of the description thereof, which follows.

### BRIEF DESCRIPTION OF THE DRAWINGS

FIG. 1 is a block diagram schematically showing an example of configuration for implementing the present invention, and in which the present invention is applied to EPMA;

FIG. 2 is a block diagram schematically showing another example of configuration for implementing the present invention, and in which the present invention is applied to EPMA;

FIG. 3 is a graph illustrating a method of displaying a spectrum measured by a wavelength-dispersive X-ray spectrometer;

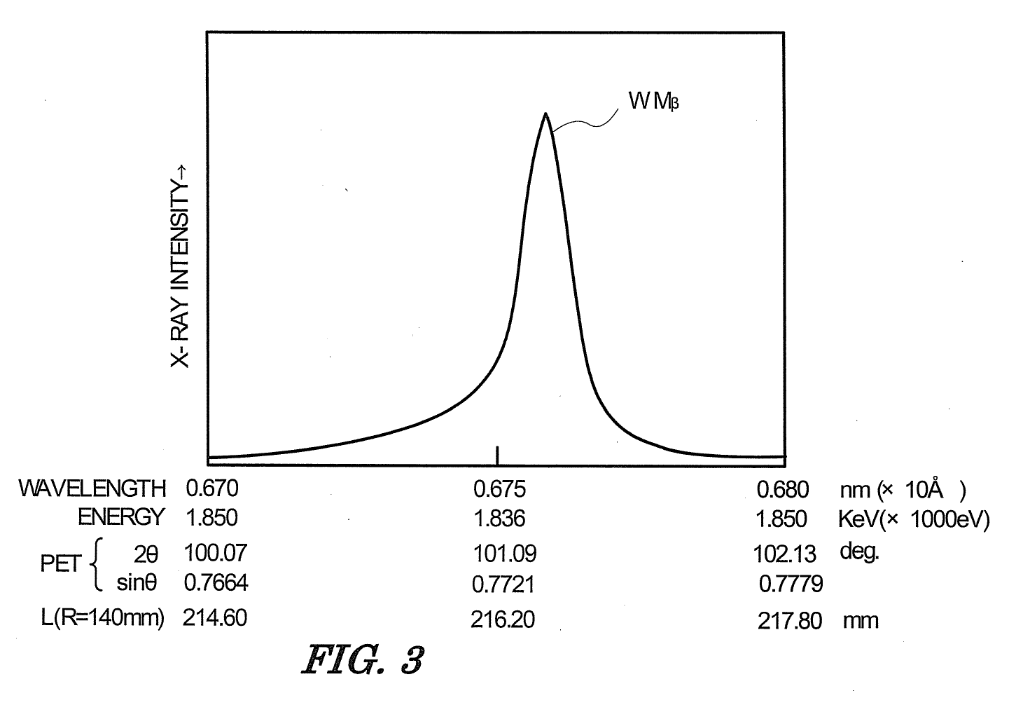

FIG. 4 is a schematic graph illustrating the relationship between first-order diffraction lines and second-order diffraction lines;

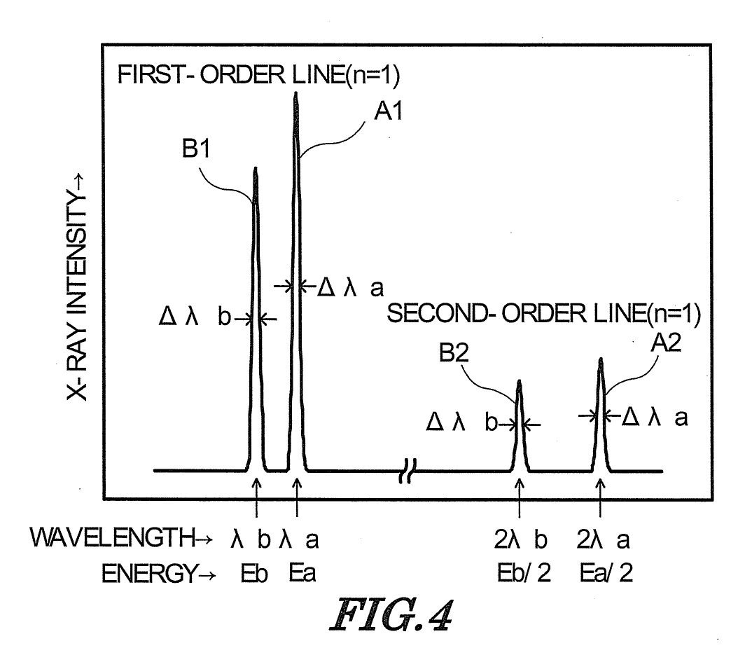

FIG. 5 is a schematic graph illustrating an example in which second-order lines of the Mg-Kα line are used for state analysis of magnesium;

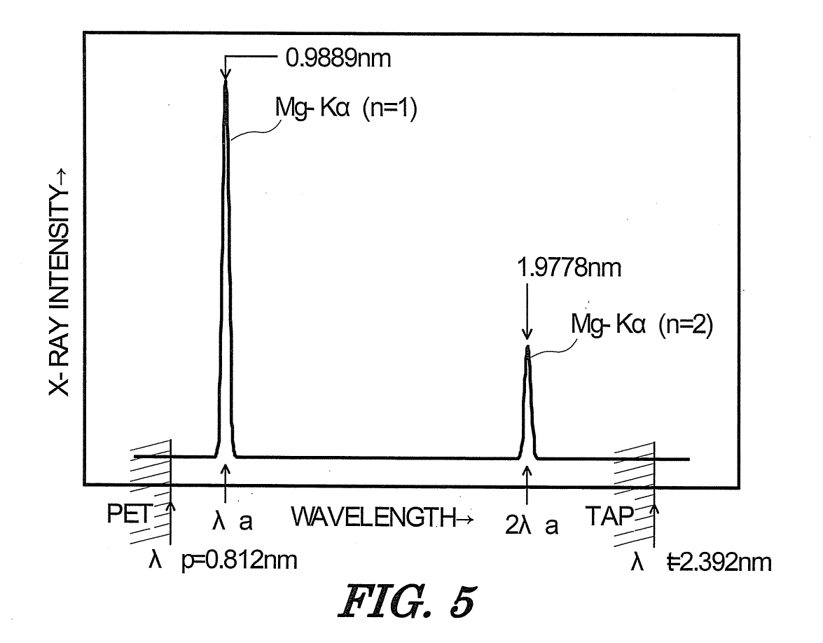

FIG. 6 is a schematic graph showing an example in which first- and second-order diffraction lines are close to each other;

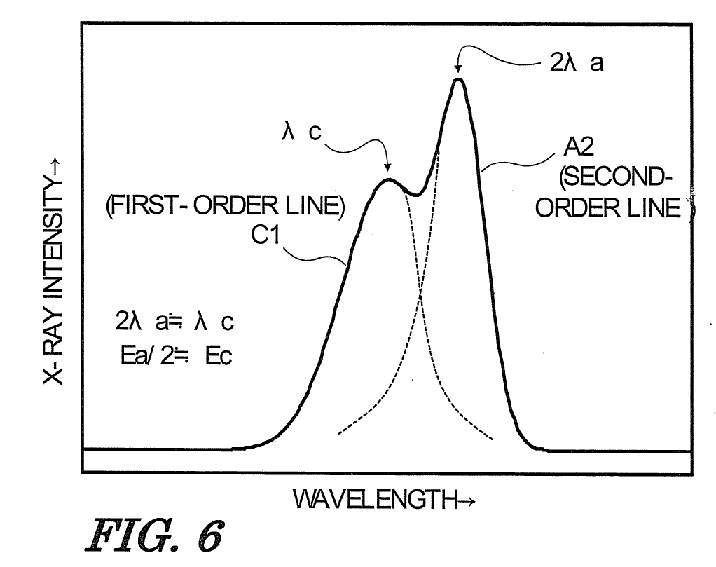

FIG. 7 is a graph illustrating a state in which only first-order lines are selected by a SCA (single-channel analyzer) incorporated in a pulse height analyzer (PHA);

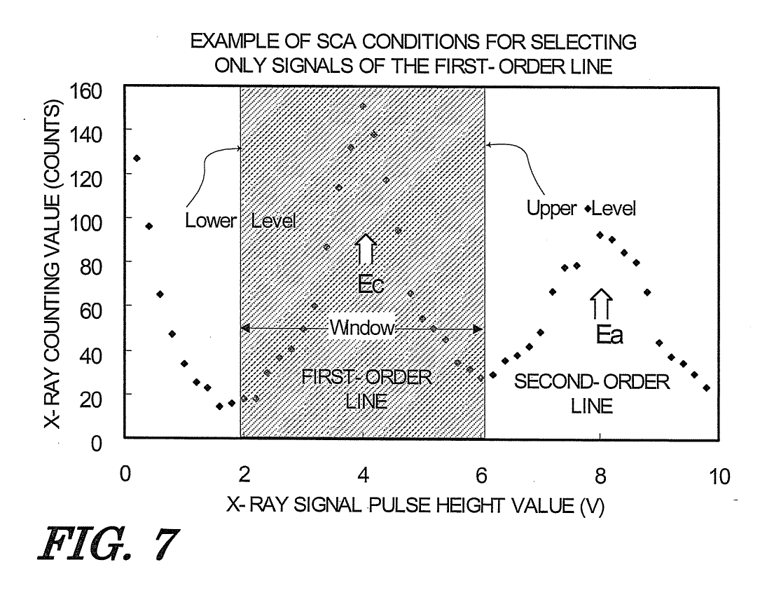

FIG. 8 is a graph illustrating a state in which only second-order lines are selected by the SCA incorporated in the pulse height analyzer;

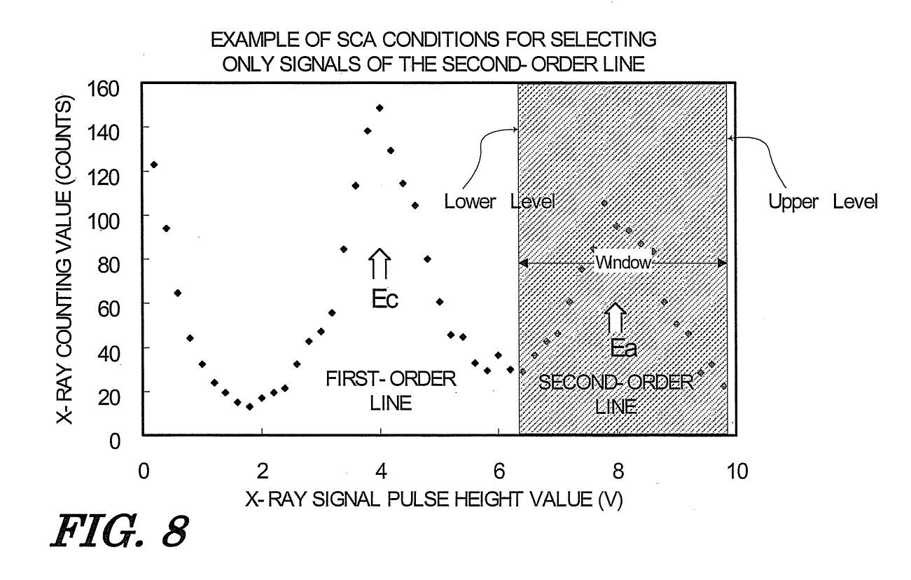

FIG. 9 is a schematic graph showing an example in which wavelengths of a spectrum of second-order lines are converted into values of first-order lines and displayed;

FIG. 10 is a schematic diagram illustrating the principle of operation of a wavelength-dispersive X-ray spectrometer incorporated in EPMA; and

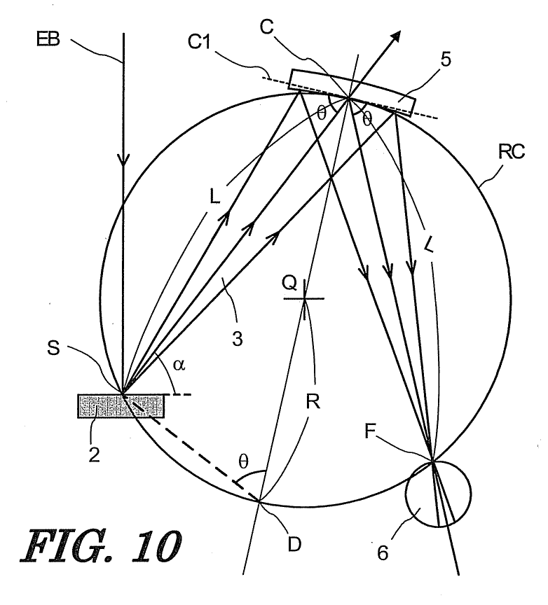

FIG. 11 is a flowchart illustrating one example of a method for implementing the present invention in EPMA.

### DESCRIPTION OF THE PREFERRED EMBODIMENTS

Embodiments of the present invention are hereinafter described with reference to the accompanying drawings. It is to be noted, however, that the technical scope of the invention is not limited thereby. In the various figures, those components operating identically or similarly are indicated by the same reference numerals and their repeated detailed description will be omitted.

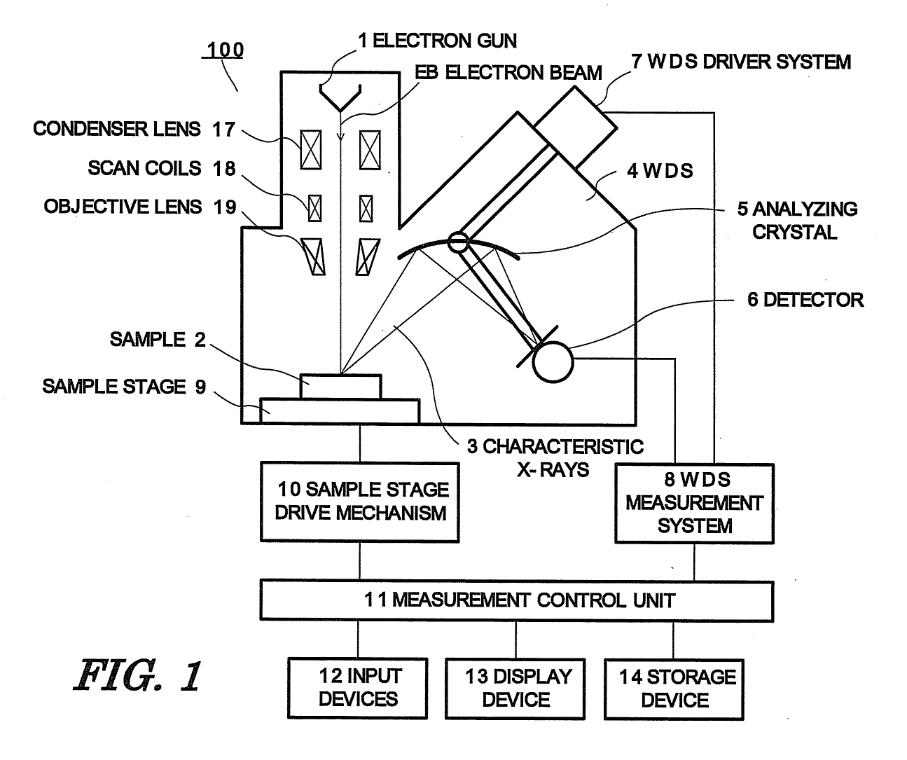

FIG. 1 is a block diagram of an EPMA (electron probe microanalyzer), schematically showing one example of configuration for implementing the present invention. An electron gun 1 emitting an electron beam EB is incorporated in the EPMA, generally indicated by reference numeral 100. The beam EB is sharply focused by a condenser lens 17 and an objective lens 19 and made to hit a sample 2. Scan coils 18 scan the beam in two dimensions. Consequently, the beam position on the sample can be modified. Characteristic X-rays 3 emitting from the sample 2 are spectrally resolved and detected by a WDS (wavelength-dispersive X-ray spectrometer) 4 including an analyzing crystal 5, a detector 6, and a WDS driver system 7. Signals are accepted via a WDS measurement system 8. The WDS 4 is controlled by a measurement control unit 11 (described later), also via the WDS measurement system 8. Where plural WDS units are mounted, plural WDS (wavelength-dispersive X-ray spectrometer) units, each identical in structure with the WDS 4, are required.

The position (i.e., analysis point) of the electron beam EB on the sample 2 placed on a sample stage 9 can be moved in the X- and Y-directions (horizontal directions) and in the Z-direction (heightwise direction) by a sample stage drive mechanism 10. The WDS measurement system 8 and sample stage drive mechanism 10 are connected with the measurement control unit 11, which, in turn, provides control and acceptance of signals necessary for measurements. A pulse height analyzer (PHA) identical in structure with the PHA already described is incorporated in the WDS measurement system 8. Input devices 12 including a keyboard and a computer mouse are connected with the measurement control unit 11. Furthermore, a display device (such as a liquid crystal display) 13 and a storage device 14 are connected with the measurement control unit 11. The characteristic X-ray wavelengths and/or energy values of various elements are stored in the storage device 14, as well as PHA measurement conditions. Parameters necessary for analysis and display of spectra (such as analyzing crystal plane spacings) are also stored in the storage device.

Actual instrumentation includes many other components, such as a vacuum pumping system for maintaining the inside of the electron optical system to a high degree of vacuum (of the order of 10⁻³ Pa), a secondary electron detector, a backscattered electron detector, a power supply, a digital-to-analog converter, and an analog-to-digital converter, but they are not directly associated with the understanding of the present invention and so they are neither shown nor described.

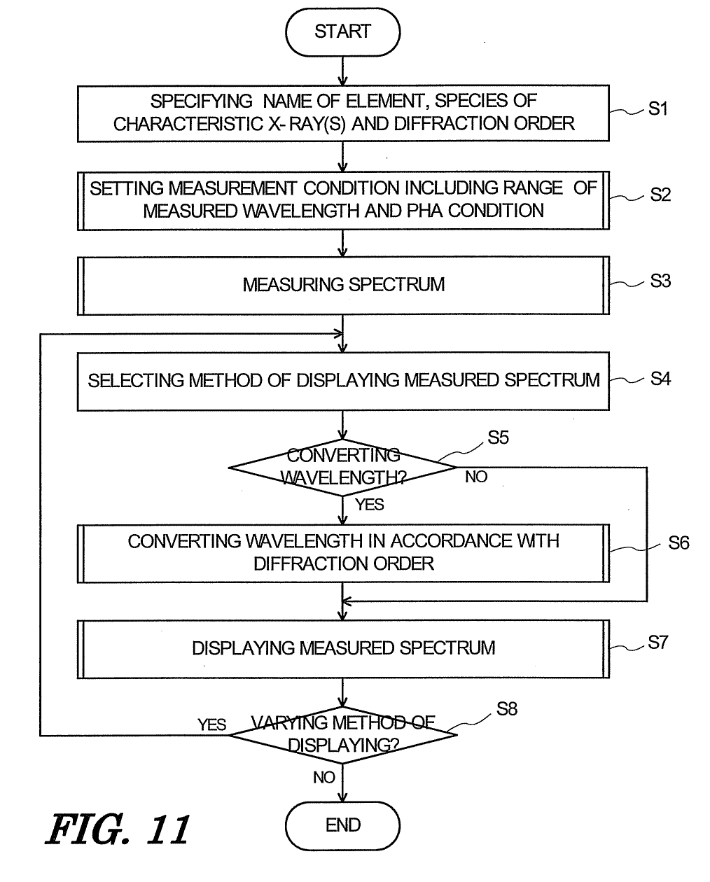

A method for implementing the present invention in the EPMA having the structure shown in FIG. 1 is next described by referring to the flowchart of FIG. 11, which illustrates the method of implementing the present invention in the EPMA.

In step S1, the operator enters the name of an element that will undergo a state analysis, a species of characteristic X-ray(s) used for the analysis, and diffraction order(s) used for the analysis, using the input devices 12. In step S2, the measurement control unit 11 reads data about the wavelengths of first-order lines from the storage device 14 in accordance with the characteristic X-ray species of the specified element and finds the actual spectral wavelength positions and range of measured wavelengths according to the diffraction order(s). Additionally, the control unit finds the energies from the wavelengths of the first-order lines. Furthermore, the control unit 11 sets the pulse height analyzer within the WDS measurement system 8 such that only X-ray signals of the specified diffraction order(s) are selected.

In step S3, the WDS driver system 7 scans the analyzing crystal 5 within the range of measured wavelengths and measures an X-ray spectrum under control of the measurement control unit 11. In step S4, the operator selects a method of displaying the measured spectra. One choice of the method of display is selection of the horizontal axis (such as wavelength, energy, or unit of representation). Another choice is to determine whether or not wavelengths are converted into the values of first-order lines. If a method of converting wavelengths into the values of the first-order lines is selected in step S5, control goes to step S6, where the wavelengths on the horizontal axis are converted into the values of the first-order lines in accordance with the diffraction order. Where the wavelengths are not converted into the values of the first-order lines, control directly proceeds to step S7.

In step S7, the measurement control unit 11 displays the measured spectrum on the display device 13 in accordance with the selected method of display. In step 8, the operator makes a decision as to whether the method of displaying a spectrum should be varied. If the method should be varied, control returns to step S4. Where the method should not be varied, the processing is terminated.

The procedure of implementing the present invention has been described so far. In the above procedure, a method of displaying a spectrum is selected by the operator after measurement of the spectrum. For example, before the measurement is started, a method of display may be selected. Alternatively, wavelengths may be automatically converted into values of first-order lines and displayed without user selections. If necessary, the operator is allowed to modify the method of display. In addition, the measurement conditions set in step S2 may be stored in the storage device 14. If only the name of an element is specified, a chemical state analysis of the element will be immediately performed.

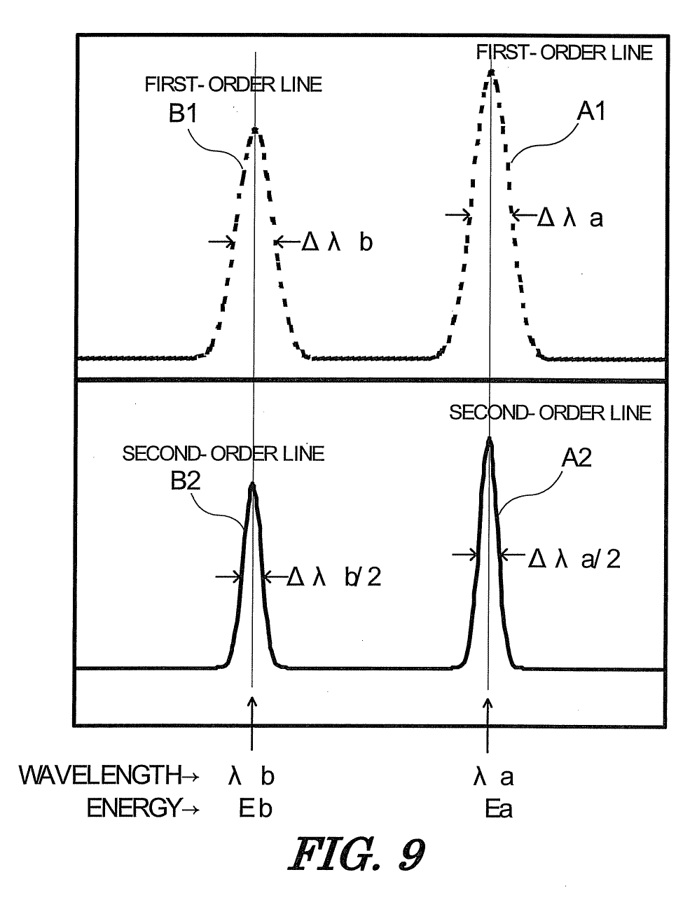

FIG. 9 is a diagram illustrating an example of a method consisting of measuring spectra of second-order lines A2 and B2 of first-order lines A1 and B1, converting the spectra into values of the first-order lines, and displaying the values. To facilitate the understanding of the improvement of the wavelength resolution of spectra, the spectra of the second-order lines are compared with the spectra of the first-order lines. In actual measurements, the spectra of the second-order lines A2 and B2 were measured within a wavelength range that is twice as wide as the range of the values displayed in FIG. 9. However, if spectra of second-order lines are converted into the values of first-order lines and displayed, the wavelength range is halved. It can be seen that the half-value widths Δλa and Δλb of the peaks are halved concomitantly and, thus, the wavelength resolution is improved twofold.

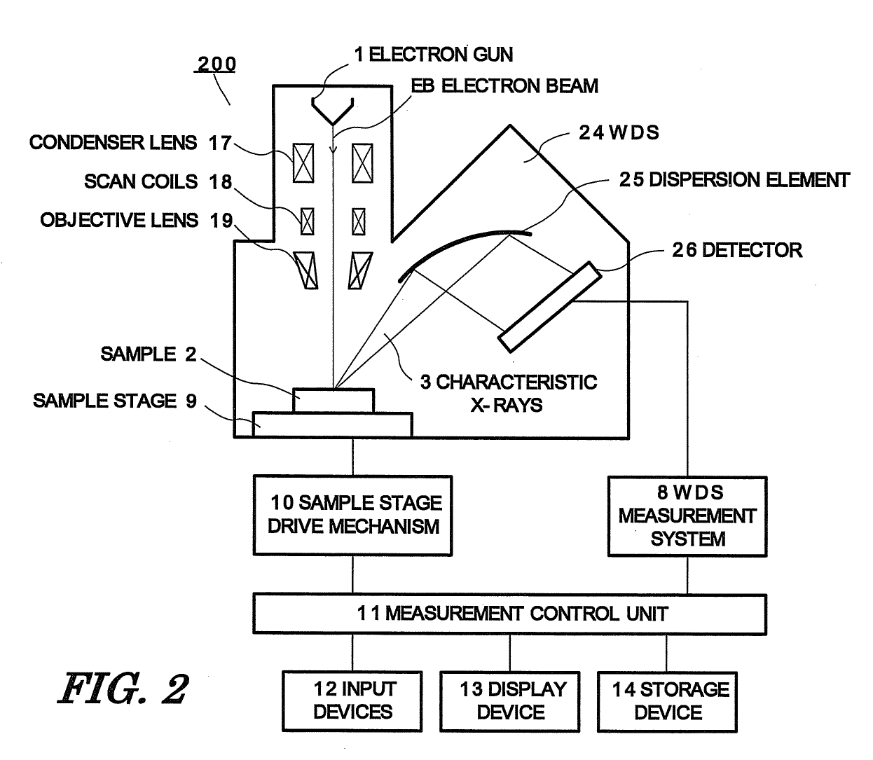

Another embodiment of the present invention in which an EPMA is taken as an example is next described by referring to FIG. 2. Those components of the EPMA, generally indicated by reference numeral 200, that operate identically or similarly to their counterparts of the EPMA 100 already described in connection with FIG. 1 are indicated by the same reference numerals as in FIG. 1. Their description will be omitted hereinafter.

The EPMA 200 has a dispersion element 25, such as a diffraction grating, and a wavelength-dispersive X-ray spectrometer (WDS) 24. The WDS 24 consists of a CCD detector 26 capable of detecting multiple wavelengths of X-rays at the same time. The WDS 4 equipped to the EPMA 100 shown in FIG. 1 measures spectra by mechanically driving the analyzing crystal 5, monochromizing the X-rays, and sequentially obtaining X-ray intensities at diffraction positions. On the other hand, the WDS 24 equipped to the EPMA 200 shown in FIG. 2 is an X-ray spectrometer capable of acquiring spectra at the same time by dispersing multiple wavelengths of X-rays at the same time and detecting them at the same time. Where the dispersion element 25 is a diffraction grating, it is desired to mount a mechanism capable of switching the used diffraction grating between plural diffraction gratings having different ranges of dispersions. In this case, a wider range of wavelengths of spectra can be measured.

In the EPMA 200, the range of measured spectra may be kept constant. Alternatively, in the same way as in the case of the EPMA 100, if the name of an element subjected to a chemical analysis, a species of characteristic X-ray, and a diffraction order are specified, optimum dispersion element and range of measured wavelengths complying with the purpose of analysis may be selected.

With respect to the spectrum acquired by the WDS 24, the horizontal axis is a wavelength axis. X-ray intensity is plotted on the vertical axis when the spectrum is displayed on the display device 13. Where higher-order lines are used for measurements, the measured spectral wavelengths are converted into values of first-order lines automatically or according to the manipulator's choice and spectra are displayed, in the same way as in the embodiment using the EPMA 100.

As described previously, when a state analysis is performed using X-ray spectra measured by a wavelength-dispersive X-ray spectrometer, higher-order diffraction lines have been heretofore often employed. However, there is the problem that where an X-ray spectrometer more automated to make measurements in elemental analysis is used, it is more cumbersome to perform a state analysis utilizing higher-order diffraction lines.

According to the present invention described above, when a state analysis is performed using higher-order diffraction lines, an X-ray spectrometer is automatically set to analytical conditions different from analytical conditions under which a general elemental analysis is performed. Thus, spectra can be measured efficiently. Furthermore, wavelengths of higher-order spectra can be automatically converted into wavelengths of the original first-order lines and displayed. Consequently, the chemical state can be analyzed quickly.

Having thus described my invention with the detail and particularity required by the Patent Laws, what is desired protected by Letters Patent is set forth in the following claims.

The invention claimed is:

1. An X-ray analysis apparatus for performing a state analysis of the chemical state in a sample by irradiating the sample with an electron beam and spectrally resolving and detecting characteristic X-rays emitting from the sample by a wavelength-dispersive X-ray spectrometer, said X-ray analysis apparatus comprising:
specifying means for specifying an element to be analyzed in terms of the chemical state, a species of characteristic X-rays used for the analysis of the element, and its order of diffraction;
setting means for setting measurement conditions under which a spectrum of the characteristic X-rays specified by the specifying means is measured; and
storage means in which parameters necessary to set the measurement conditions are stored,
wherein the setting means reads out the parameters stored in the storage means based on the species of the characteristic X-rays and its order of diffraction specified by the specifying means and sets the measurement conditions under which the spectrum of the characteristic X-rays is measured.

2. An X-ray analysis apparatus as set forth in claim 1, wherein at least (i) energy and/or wavelength of the characteristic X-rays specified by the specifying means, (ii) a kind of X-ray analyzing crystal capable of measuring a spectrum of the characteristic X-rays specified by the specifying means, and (iii) a plane spacing of the X-ray analyzer are stored in the storage means.

3. An X-ray analysis apparatus as set forth in any one of claims 1 and 2, wherein said setting means has means for setting a pulse height analyzer of an X-ray detection system for detecting the characteristic X-rays in such a way as to detect only diffraction lines of the second or higher order specified by the specifying means when the characteristic X-rays specified by the specifying means are diffraction lines of the second or higher order.

4. An X-ray analysis apparatus as set forth in claim 1, further comprising: conversion means for converting wavelengths of a characteristic X-ray spectrum measured under the above-described measurement conditions into wavelengths of a spectrum of first-order diffraction lines; and display means for displaying the spectrum obtained by the conversion.

5. An X-ray analysis apparatus for analyzing the chemical state in a sample by irradiating the sample with an electron beam and spectrally resolving and detecting characteristic X-rays emitting from the sample by a wavelength-dispersive X-ray spectrometer, said X-ray analysis apparatus comprising:
specifying means for specifying an element to be analyzed in terms of the chemical state, a species of characteristic X-rays used for the analysis of the element, and its order of diffraction;
conversion means for converting wavelengths of a characteristic X-ray spectrum measured based on the species of characteristic X-rays and order of diffraction specified by the specifying means into wavelengths of a spectrum of first-order diffraction lines; and
display means for displaying the spectrum obtained by the conversion.

6. A method of X-ray analysis for analyzing the chemical state in a sample by irradiating the sample with an electron beam and spectrally resolving and detecting characteristic X-rays emitting from the sample by a wavelength-dispersive X-ray spectrometer, said method comprising the steps of:
specifying an element to be analyzed in terms of the chemical state, a species of characteristic X-rays used for the analysis of the element, and its order of diffraction;
setting measurement conditions under which a spectrum of the specified characteristic X-rays is measured;
reading parameters necessary to set the measurement conditions from storage means, based on the specified species of characteristic X-rays and its order of diffraction; and
then setting the measurement conditions under which the spectrum of the characteristic X-rays is measured.

7. A method of X-ray analysis for analyzing the chemical state in a sample by irradiating the sample with an electron beam and spectrally resolving and detecting characteristic X-rays emitting from the sample by a wavelength-dispersive X-ray spectrometer, said method comprising the steps of:
specifying an element to be analyzed in terms of the chemical state, a species of characteristic X-rays used for the analysis of the element, and its order of diffraction;
converting wavelengths of a spectrum of the characteristic X-rays measured based on the specified species of characteristic X-ray and order of diffraction into wavelengths of a spectrum of first-order diffraction lines; and
displaying the spectrum obtained by the conversion.
